(19) United States
(12) Patent Application Publication
(10) Pub. No.: US 2019/0005558 A1
(43) Pub. Date: Jan. 3, 2019

(54) SYSTEM FOR MANAGING SECURE TRANSFERRABLE CREDIT

(71) Applicant: PREZZEE PTY LTD, Surry Hills, New South Wales (AU)

(72) Inventors: Claire Morris, Surry Hills, New South Wales (AU); Matthew Hoggett, Surry Hills, New South Wales (AU); Daniel Morrison, Surry Hills, New South Wales (AU); Pablo Grigolatto, Surry Hills, New South Wales (AU); Matthew Yuan, Surry Hills, New South Wales (AU)

(21) Appl. No.: 15/781,348

(22) PCT Filed: Nov. 30, 2016
(86) PCT No.: PCT/AU2016/051170

§ 371 Date: Jun. 4, 2018

(30) Foreign Application Priority Data
Dec. 4, 2015 (AU) 2015905030

(51) Int. Cl. G06Q 30/06; G06Q 20/40; G06F 17/30

(52) U.S. Cl. CPC G06Q 30/0621; G06F 17/30554; G06Q 30/0641; G06Q 20/40

(57) ABSTRACT

Described are implementations for creating a personalised data package having an associated value of merchant-specific credits, including a server configured to receive a request from a customer terminal for creation of a personalised data package. The Server then accesses a payment gateway to obtain secure payment of an amount representative of the merchant-specific credits. In response to receiving the payment, the server accesses a database to generate a visual template, for the personalised data package, indicative of a visual representation of the personalised data package. The Server then provides an interface to allow personalisation of the visual template, including: uploading and embedding of image and/or video to the data package, embedding of personalised text content, embedding of audio content, and/or embedding of interactive content to the data package. The personalised data package is able to be accessed by the specified recipient via a recipient terminal.

### FIELD OF THE INVENTION

The present application relates to secure transfer of credit in an online environment. More specifically, embodiments of the present invention relate to systems for managing merchant-specific credit in the form of gift cards or pre-paid cash cards having an associated credit value.

While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Gift cards were long regarded as one of the most preferred gifts for both men and women. First generation gift cards were realised as physical plastic cards with an associated value. They are not ubiquitous, and as such the opportunity to redeem requires the customer to be physically present in-store for redemption.

Second generation gift cards included plastic cards with magnetic data strips to link with electronic credit associated with that card. These second generation gift cards are able to be used at point-of-sale (POS) terminals in-store in a similar manner to credit or debit cards. Additionally, the second generation cards had a unique identifier which could be entered into a coupon field when shopping online, thus avoiding the need for the customer to be physically present in-store for redemption.

These first and second generation physical gift cards have a number of disadvantages, including:
They are easy to lose or misplace;
They add bulk to a user's wallet or purse; and
They contain convoluted expiry dates which can be easily missed.

As retail commerce increases digitally, plastic gift cards are gradually being replaced by a third generation of cards in the form of entirely electronic gift cards for reasons such as increased flexibility and distribution potential. With the advent of digital wallets, electronic gift cards can be easily purchased and downloaded into a user's digital wallet.

Electronic gift cards often take the form of secure credit offered between two dedicated parties in an online environment. Electronic gift cards are able to address each of the above problems and provide many more advantages. However, electronic gift cards still suffer the association of being a thoughtless or last minute gift. Furthermore, conversion of credit between different merchants is not possible as the purchased credit is typicallly merchant-specific.

It is therefore desirable to develop a system for developing electronic gift cards into more flexible and personalised electronic gifts.

### SUMMARY OF THE INVENTION

In accordance with a first aspect of the present invention there is provided a system for creating one or more personalised data packages, each having an associated value of merchant-specific credits, the system including a server configured to:
receive a request from a customer terminal for creation of one or more personalised data packages, the request including one or more specified recipients, one or more specified merchants selected from a plurality of merchants and a specified value of merchant-specific credits specific to the specified merchants for each of the personalised data packages;
access an online payment gateway to obtain secure payment of an amount representative of the total value of merchant-specific credits for all of the personalised data packages;
in response to receiving the secure payment, access a database to generate a visual template for each of the personalised data packages, the visual template being indicative of a visual representation of the personalised data packages when rendered on an electronic display; and
provide an interface accessible by the customer terminal to allow personalisation of the visual template to update the personalised data packages to include one or more of:
   uploading and embedding of image and/or video content to the data packages;
   embedding of personalised text content to the data packages;
   embedding of audio content to the data packages; and
   embedding of interactive content to the data packages;
wherein the personalised data packages are able to be accessed by the specified recipients via recipient terminals.

In one embodiment the visual template includes a logo of the specified merchant.

Preferably the server is further configured to electronically transmit the personalised data package to a specified recipient. In one embodiment transmitting the personalised data package includes emailing the personalised data package to the specified recipient. In another embodiment transmitting the personalised data package includes emailing a link to the personalised data package to the specified recipient. In a further embodiment transmitting the personalised data package includes uploading the personalised data package to a social media account of the specified recipient. In a still further embodiment transmitting the personalised data package includes uploading a link to the personalised data package to a social media account of the specified recipient. In other embodiments, the personalised data package can be electronically transmitted as any kind of digital notification, including any one or more of a push notification, calendar event and SMS notification.

In one embodiment the personalised data package includes data indicative of an expiry date for using the specified value of merchant-specific credits.

In some embodiments the server is further configured to issue a notification to the specified recipient about the expiry date at a predetermined time before the expiry date. In one embodiment the notification includes an email. In one embodiment the notification includes an alert on a social media account of the specified recipient. More generally, the notification can include any kind of digital notification, including any one or more of a push notification, calendar event, SMS notification and phone call.

In one embodiment the interactive content includes visual content renderable on a display of an electronic device which requires input by the specified recipient at an interface to selectively reveal the specified value.

Preferably the customer terminal and recipient terminal include digital devices such as personal or public computers, laptop computers, tablet computers, smart watches and Smartphones.

In one embodiment the personalised data package includes a unique reference identifier. In one embodiment the personalised data package includes a timestamp and datestamp corresponding to the time and date that it was activated and/or created.

In one embodiment the personalised data package is in a format such that it can be stored in a digital wallet and the credit redeemed at a point of sale using the digital wallet.

In one embodiment the personalised data package is able to be sold or traded through the interface.

In one embodiment the server is configured to allow the recipient to access the interface to change the specified merchant to another merchant registered with the system.

In one embodiment the server is configured to allow the recipient to access the interface to modify the personalised data package.

In one embodiment the interface is made available to the customer terminal upon entering preregistered login details to access a user account.

In one embodiment the secure payment is performed using a token-based authentication protocol.

In one embodiment the interface is a proprietary software application executable on a mobile device. In another embodiment the interface is a web page executable through a web browser.

In some embodiments the merchant is an entity associated with the system. In one embodiment, the merchant associated with the system holds credits in escrow which can be converted to credits specific to another merchant.

In one embodiment, the payment is received by the server accessing an online payment gateway.

In accordance with a second aspect of the present invention there is provided a method for creating one or more personalised data packages, each having an associated value of merchant-specific credits, the method including:
a) receiving a request from a customer terminal for creation of one or more personalised data packages, the request including one or more specified recipients, one or more specified merchants and a specified value of merchant-specific credits specific to the specified merchants for each of the personalised data packages;
b) accessing an online payment gateway to obtain secure payment of an amount representative of the total value of merchant-specific credits for all of the personalised data packages;
c) in response to receiving the secure payment, accessing a database to generate a visual template for each of the personalised data packages, the visual template being indicative of a visual representation of the personalised data package when rendered on an electronic display;
d) providing an interface accessible by the customer terminal through a server to allow personalisation of the visual template to update the personalised data packages to include one or more of:
   uploading and embedding of image and/or video content to the data packages;
   embedding of personalised text content to the data packages;
   embedding of audio content to the data packages; and
   embedding of interactive content to the data packages; and
e) providing access to the personalised data packages by the specified recipient via recipient terminals.

In accordance with a third aspect of the present invention there is provided a system for converting a currency payment into a value of merchant-specific credit to be used at one of a plurality of subscribed merchants, the system including a server configured to:
provide an interface accessible by a customer terminal for receiving a request from an input user device for a specified value of merchant-specific credit that is specific to one of the subscribed merchants, the request including the specified value and a specified merchant;
in response to the request, determining a current value of credits held on account for the specified merchant;
if the current value of credits is less than the specified value, communicate electronically with a server of the specified merchant to place a purchase order with the specified merchant for at least the difference between the current value of credits and the specified value, the purchase order being carried out using the specified e-commerce protocols of the specified merchant;
provide access of the customer terminal to a payment gateway for securely transferring the currency payment for the specified value to a third party; and
in response to the secure transfer of the currency payment, allocate the specified amount of merchant-specific credit to an account of a user;
wherein the merchant-specific credit is able to be redeemed at a point-of-sale interface of the specified merchant.

In some embodiments at least two of the subscribed merchants include different specified e-commerce protocols.

In some embodiments the point-of-sale interface of the specified merchant includes a web online interface accessible by a customer terminal.

In other embodiments the point-of-sale interface of the specified merchant includes an in-store physical point-of-sale terminal.

### BRIEF DESCRIPTION OF THE DRAWINGS

Example embodiments of the disclosure will now be described, by way of example only, with reference to the accompanying drawings in which:

FIG. 1 is a schematic illustration of a system for creating a personalised data package and for converting a currency payment into a value of merchant-specific credit to be used at one of a plurality of subscribed merchants;

FIG. 2 is a method performed by the system of FIG. 1;

FIGS. 3 to 6 are screenshots of an exemplary electronic gift card as viewed in a mobile app on a mobile device;

FIG. 7 is a schematic functional diagram of illustrating functional components of the system of FIG. 1;

FIG. 8 is a schematic functional diagram illustrating process flow in a user authentication process; and FIG. 9 is a schematic functional diagram illustrating process flow in an online secure

payment process.

### DESCRIPTION OF EXAMPLE EMBODIMENTS

### Overview

The present invention relates to the efficient and secure management of merchant-specific credit in an online environment. The embodiments described herein are described with reference to electronic gift cards as examples of merchant-specific credit. However, it will be appreciated by those skilled in the art that the invention applies more broadly to other forms of securable transferrable credit such as pre-paid cash cards or coupons having an associated credit value.

Throughout this specification, the terms ‘data package’ or ‘personalised data package’ are used to refer to the underlying digital data structure of the electronic gift card or electronic cash card as stored on memory and/or manipulated by a processor while the terms ‘electronic gift card’ are used to refer to the card when it is graphically represented on a display of a computer device. The data package includes data on how the gift card should be rendered graphically and may or may not be securely encoded.

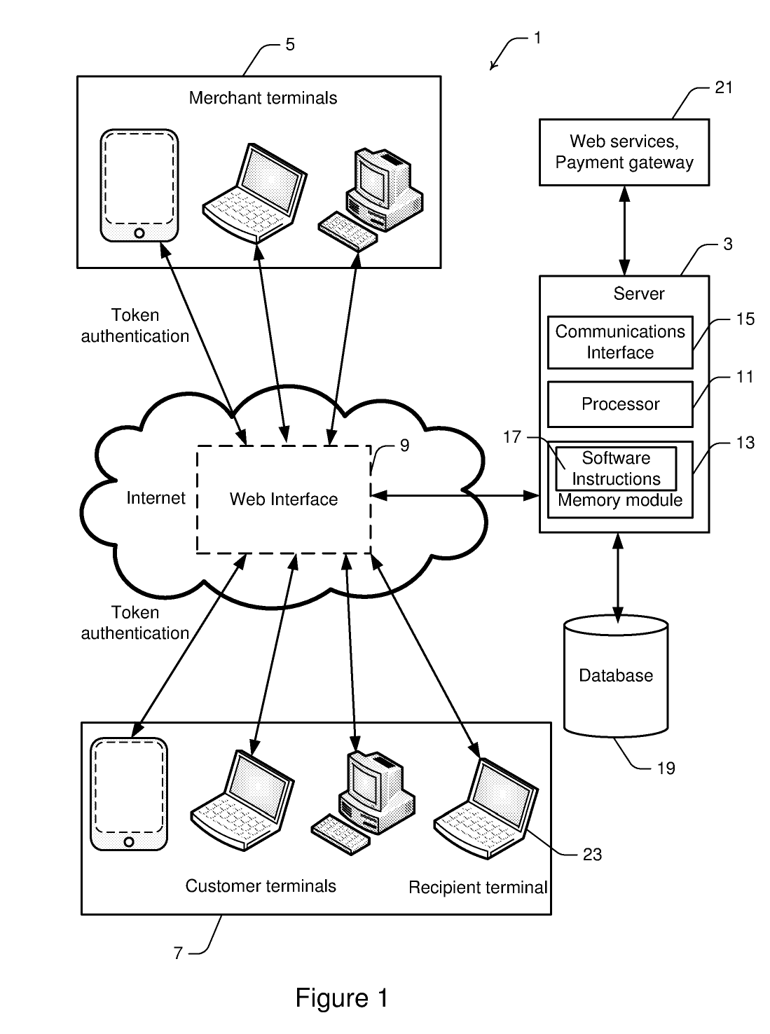

Referring to FIG. 1 there is illustrated system hardware for operating a system 1 for creating a personalised data package such as an electronic gift card. System 1 is also capable of converting a currency payment into a value of merchant-specific credit to be used at one of a plurality of subscribed merchants, as will be described below. However, initially system 1 will be described in relation to creating a personalised data package.

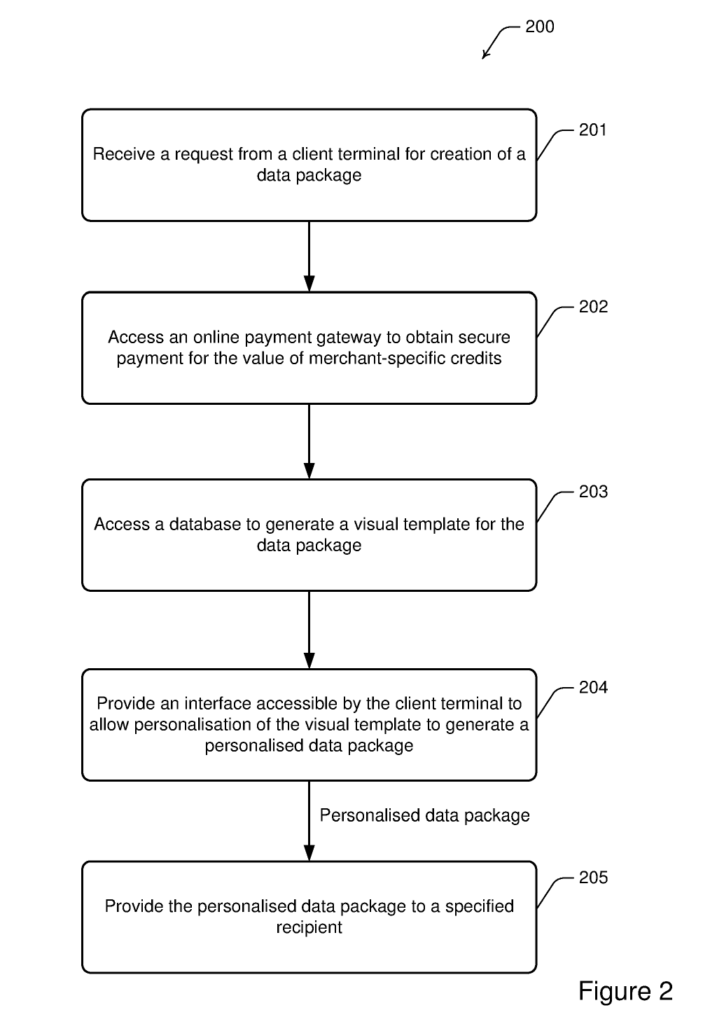

The data package includes an associated embedded value of merchant-specific credits or, alternatively, credits held in escrow (“escrow credits”) by the platform which can be used at a number of merchants, as well as other content to personalise the data package for an intended recipient as described below. System 1 includes a central server 3 which is configured to communicate with other hardware to perform the steps of method 200 illustrated in FIG. 2.

As illustrated in FIG. 1, server 3 represents a central communication point between merchant terminals 5, such as central servers of shops or department stores, and customer terminals 7 used by customers such as personal or public computers, laptop computers, tablet computers, smart watches and Smartphones. More generally, customer terminals 7 can be realised as any digital device. Server 3 hosts a web interface 9 available for accessing over the internet by both the merchant terminals 5 and customer terminals 7 Web interface 9 can take the form of a website that is renderable on displays of personal computers, laptops and the like. Web interface 9 can also take the form of a third party software application (referred to hereinafter as a ‘mobile app’) that is downloadable to a mobile device such as a tablet computer or a Smartphone. Typically, both the website and mobile app are available to provide broad access to customers both at home and on-the-go.

Server 3 includes a processor 11 coupled to a memory module 13 and a communications interface 15, such as an Internet connection, modem, Ethernet port, wireless network card, serial port, or the like. In other embodiments distributed resources are used. For example, in one embodiment server 3 includes a plurality of distributed servers having respective storage, processing and communications resources. Memory module 13 includes software instructions 17, which are executable on processor 11.

Server 3 is coupled to a database 19, which, in some embodiments, represents a cloud-based data resource. In further embodiments database 19 leverages memory module 13.

The operation of server 3 and system 1 will be described with initial reference to both FIGS. 1 and 2.

At step 201 of method 200, server 3 receives a request from a customer using a customer terminal 7 for the creation of a personalised data package or a plurality of personalised data packages. The request is made by entering data to relevant fields through web interface 9. The request includes, inter alia, data indicative of a specified recipient such as a friend or family member to whom the gift card is intended, data indicative of a specified value of merchant-specific credits and a specified merchant for which those credits apply. In the case where a user wishes to purchase a data package that can be used at a number of registered merchants, the user selects a dedicated card in which the platform administrator or another entity is listed as the merchant and the value of credits is held in escrow by the platform until that credit is converted into credits of a registered merchant. In some embodiments of the invention, the request also includes a requested template or format that the electronic gift card will look like once graphically represented. However, as will be described below, the customer is presented with the option to customise the personalised data package or packages after the initial request.

In some embodiments the interface is made available to the customer terminal upon entering preregistered login details to access a user account. The user account and login details are set up in a registration step similar to registering user accounts for web pages.

At step 202, server 3 accesses an online payment gateway 21 operated by a payment service provider such as Braintree™ to obtain secure payment of an amount representative of the value of merchant-specific or escrow credits. The amount may include the value of merchant-specific or escrow credits plus one or more fees or commissions paid to the merchant or other service providers such as payment services and/or an administrative fee for use of system 1. In the case where multiple personalised data packages are purchased, the amount may include the total value of the merchant-specific or escrow credits plus a single fee or commission or a fee or commission for each of the data packages purchased.

In some embodiments, the secure payment is performed using a token-based authentication protocol, as described below. In other embodiments, server 3 is able to access an account or receive input which verifies other types of payment such as bank transfers, cash payments, cheque deposits, bitcoin or other blockchain-type payment systems.

At step 203, in response to receiving the secure payment, server 3 accesses database 19 to obtain graphical data to generate a visual template for the personalised data package. The visual template is indicative of a visual representation of the personalised data package when it is rendered on an electronic display (such as a computer screen or a graphical user interface of a mobile device). That is, the template represents a graphical framework from which the electronic gift card will be rendered. The template may include one or more data structures having indexes for storing and sourcing data from database 19, including the data received in the input request. By way of example, the template may include HTML data, image data, video data, audio data or combinations thereof. The template may be indicative of a predefined form provided by the specified merchant or may be a custom template requested by the customer at step 201. By way of example, a visual template may include a logo or trade mark of the specified merchant.

At step 204, server 3 provides an interface accessible by the customer terminal 7 to allow personalisation of the visual template to update the personalised data package to include various personalised content. The interface presented to the customer may represent a specific web page of the web site of interface 9 or a page of the mobile app including various fields, drop-down menus and other widgets for enabling personalisation of the data package. In particular, the interface allows the modification of the data representing the visual template to include personalised content including one or more of:
uploading and embedding of photo and/or video content to the data package;
embedding of personalised text content to the data package; and
embedding of interactive content to the data package.

Finally, at step 205, the personalised data package is made available on server 3 to be accessed by the specified recipient on a recipient terminal. By way of example, the personalised data package is stored in database 19 where it can be accessed by the recipient on a recipient terminal 23 through interface 9. More particularly, the use of data structures allows the data associated with the personalised data package to be stored separately and accessed and collated by appropriate indexing of the data structure(s). As such, the personalised data package need not represent a single collection of data as in an image but may represent a set of instructions which, when executed, collate the necessary data to function as an electronic gift card.

In one embodiment, server 3 is further configured to generate and electronically transmit the personalised data package (or a link to access the data package) to the specified recipient by way of email or uploading the personalised data package to a social media account of the specified recipient for subsequent download and/or activation. In other embodiments, the personalised data package can be electronically transmitted as any kind of digital notification, including any one or more of a push notification, calendar event and SMS notification.

In some embodiments, activation of the personalised data package involves clicking an activation link in an email or on a HTML page which sends a confirmation to both server 3 and the merchant terminal of the specified merchant. Once activated, the electronic gift card represents a line of credit that can be redeemed to purchase goods or services from the specified merchant. The credit can be redeemed in a number of ways. Firstly, the electronic gift card can be downloaded to a digital wallet mobile app and used as a debit type card. The digital wallet can be used in-store using a mobile device preloaded with the digital wallet software and appropriate near field communication (NFC) or Bluetooth™ hardware to communication wirelessly with a merchant terminal. Secondly, the digital wallet can be used online through the specified merchant's e-commerce systems. The electronic gift card can be redeemed using a unique identifier code that is associated with the gift card and stored on a database of the specified merchant. The web interface of the e-commerce system of the specified merchant provides an option to enter the unique identifier upon completing a purchase through its online e-commerce system. The identifier is checked against the merchant's record to obtain the credit value of that electronic gift card and this credit value is applied to the current transaction.

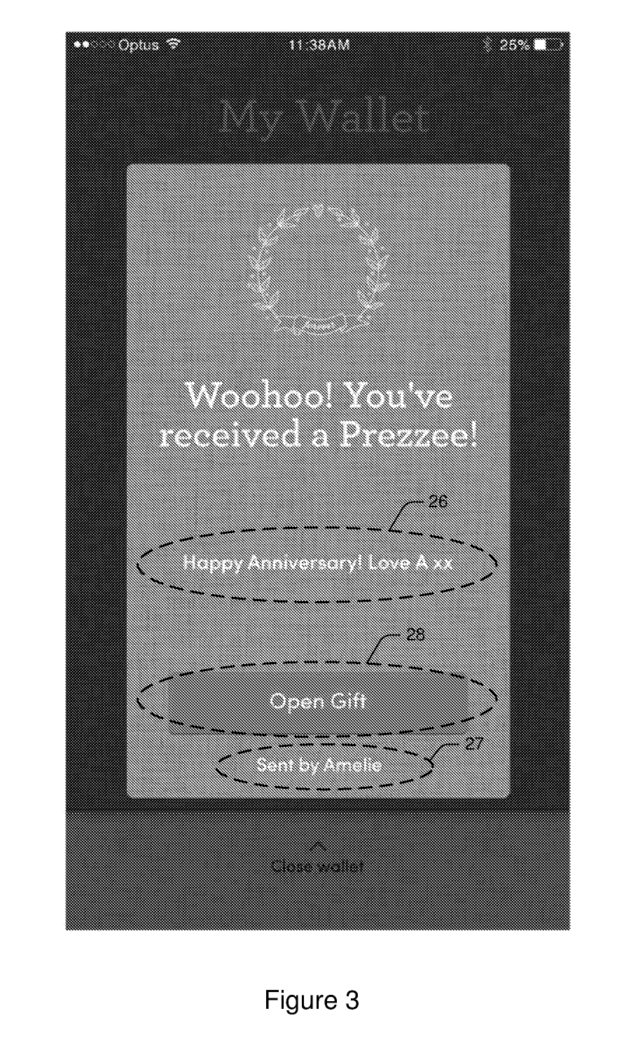

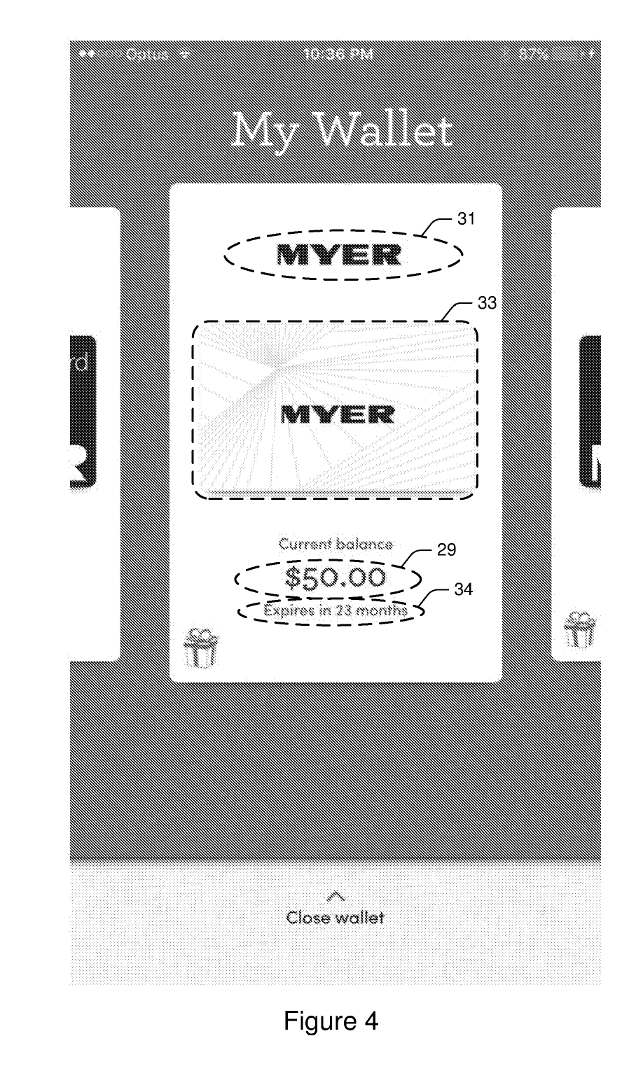

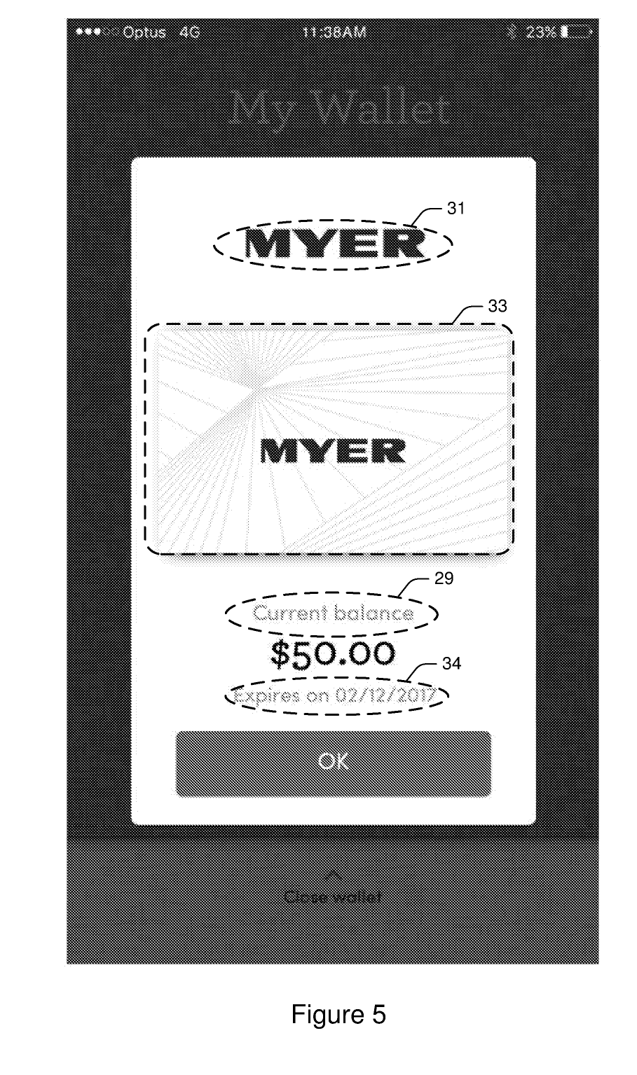

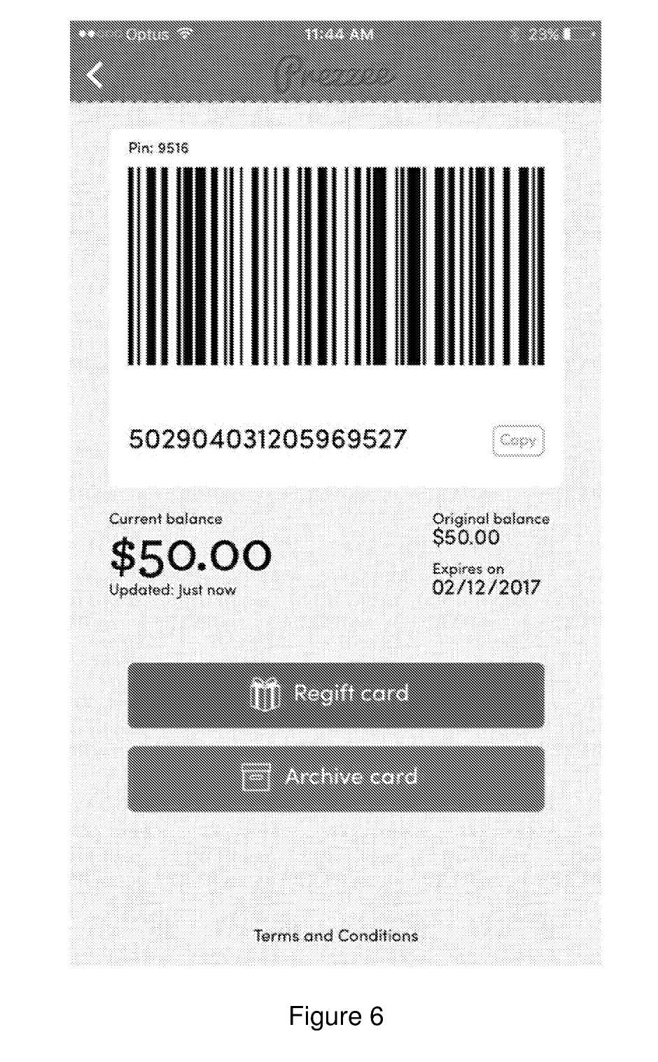

When the personalised data package is opened by the recipient, it is represented graphically on a display of the recipient terminal as an electronic gift card. Screenshots of an exemplary personalised electronic gift card 25, as rendered on a display of a mobile device running the mobile app, are illustrated in FIGS. 3 to 6. A first screen illustrated in FIG. 3 is displayed initially upon receipt of an electronic gift card. This screen displays a personalised message 26 to the recipient, a sender 27 of the gift card and a button 28 to open the electronic gift card. FIGS. 4 and 5 represent alternative views of a second screen of the mobile app, which illustrates a value 29 of merchant specific credits, the specified merchant 31, including a merchant-specific graphic 33 and an expiry period/date 34. In some embodiments, the expiry date is set by the merchant. In these embodiments, the electronic gift card is embedded with data indicative of an expiry date for using the specified value of merchant-specific credits. FIG. 6 represents a third screen of the mobile app, which illustrates various information and options associated with the electronic gift card including a four digit pin 35, bar code 36 and an associated unique card identification number 37. The pin code 35 can be used to authenticate purchases using the electronic gift card. The identification number 37 is used for accounting purposes to reference the current/remaining value of merchant-specific credit.

Although not shown, the associated data package may include further information such as the time and date that the card was created. It will be appreciated that various embodiments of the electronic gift card include more or less content.

In some embodiments server 3 is configured to monitor expiry dates of electronic gift cards and issue notifications to the specified recipient about the expiry date at a predetermined time before the expiry date. Expiry periods are set by the merchants upon issuing an electronic gift card and this data is captured by server 3 and stored in database 19 in association with the electronic gift card. The expiry date of a gift card is defined from the date the electronic gift card is activated and ends after the duration of the specified expiry period. To monitor these expiry dates, the electronic gift card may include a timestamp and datestamp corresponding to the time and date that it was activated and/or created.

Exemplary notifications may be by email or an alert on a social media account of the specified recipient. More generally, the notifications can be any kind of digital notification, including any one or more of a push notification, calendar event, SMS notification and phone call. The notifications may also include the current remaining credit associated with that electronic gift card.

The interactive content includes content displayed on a display of a device which requires input by the specified recipient at an interface to selectively reveal the specified value. By way of example, the interactive content may include a scratch panel covering the gift card which must be removed by the recipient performing a scratching motion across a touch interface of a mobile device to reveal the gift card details.

In some embodiments, interface 9 provides advanced functionality to perform other functions such as selling or trading the electronic gift card to other subscribers of system 1. Server 3 may be configured to allow the recipient to access the interface to modify the electronic gift card, either by adding credit value or changing the appearance of the electronic gift card, as rendered on a display.

If the user has the mobile app installed on a specific device, and the link was clicked from that device, the application is configured to open automatically to receive the electronic gift card. If not, a page is displayed with the card details, an invitation to install the mobile app and the user can print the card for later redemption The user is also shown a unique code that they can use to add a received card to their digital wallet if they install the mobile app at a later stage.

In operation, database 19 typically includes an inventory of units of non-personalised data packages from merchants subscribed to system 1. Once payment for a gift card is confirmed, a unit of the inventory is allocated to the order and the specified merchant is notified. The date of the purchase is stored in database 19 in association with that personalised data package.

A central aspect of the present invention is the ability to integrate with the various merchant terminals and their associated e-commerce systems, which typically vary widely. To achieve this, one aspect of the present invention is to convert a currency payment into a value of merchant-specific credit to be used at one of a plurality of subscribed merchants. System 1 performs this process through server 3 by:
providing interface 9 accessible by customer terminals 7 for receiving a request from an input user device for a specified value of merchant-specific credit that is specific to one of the subscribed merchants, the request including the specified value and a specified merchant;
in response to the request, communicating electronically with a merchant terminal 5 of the specified merchant to place a purchase order with the specified merchant for the specified value, the purchase order being carried out using the specified e-commerce protocols of the specified merchant;
providing access of the customer terminal 7 to payment gateway 21 for securely transferring the currency payment for the specified value to the specified merchant; and
in response to the secure transfer of the currency payment, allocating the specified amount of merchant-specific credit to an account of a user, wherein the merchant-specific credit is able to be redeemed at a point-of-sale interface of the specified merchant.

### Exemplary System Implementation

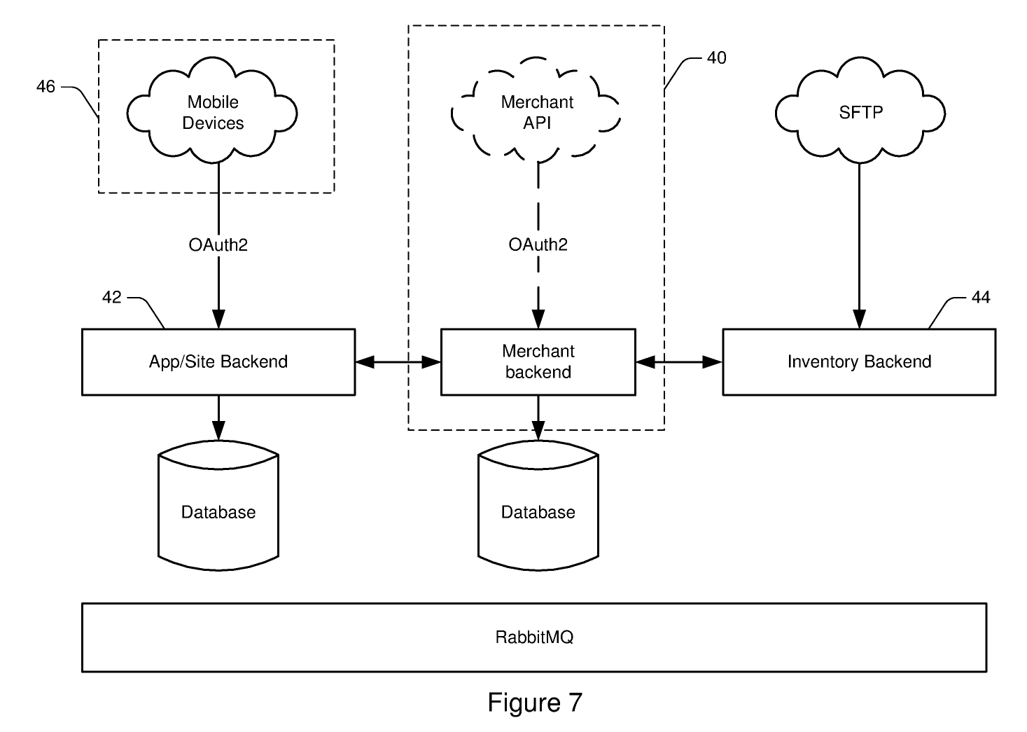

Exemplary system operation to perform the above functionality is illustrated in the functional diagram of FIG. 7. Functionally, the system includes four core elements as illustrated in FIG. 7: 1) the merchant platform 40; 2) the app/site backend 42; 3) the inventory backend 44; and 4) the mobile app 46 (Including Apple® iOS, Google® Android, Microsoft® Windows Mobile and other operating system compatible versions).

Inventory is uploaded to a merchant SSH File Transfer Protocol (SFTP) account after purchase by system 1. At this stage, the inventory is un-activated. It cannot yet be redeemed.

On an inventory server:
1. A Celery task monitors the upload directories and when it sees a new file,
2. It moves it out of the directory and sends a message to a RabbitMQ queue with the path to the file.
3. A series of Celery workers are set up to monitor the upload queue and process the inventory files as they come in.

Some embodiments of the invention utilise a merchant API to allow merchants to push their inventory to system 1 via HTTPS, activate cards and update inventory with balances.

Besides the four core elements, the invention is able to leverage additional cloud-based services to provide specific application functionality such as:
secure online payments (for example, using Braintree™),
notifications (for example, using Parse™),
monitoring and analytics (for example, using New Relic™),
CDN content delivery web services (for example, using AWS Cloudfront by Amazon®),
hosting (for example, using AWS EC2 by Amazon®),
Postgres services in cloud (for example, using AWS RDS by Amazon®),
Messaging services such as RabbitMQ™ for messaging and as a distributed task queue,
High performance cache management using a service such as Redis.

Traffic to and from the web interface is managed by an Elastic Load Balancer that scales with a change in volume of traffic.

### The Merchant Backend

The Merchant backend provides for system administrators to manage inventory and orders for merchants. It also provides the inventory application programming interface (API) for the app/site backend to fetch and update user digital wallet and/or card details. Communication between the app/site backend and the merchant backend is over Secure Sockets Layer (SSL).

A merchant API allows merchants to push their inventory to the system via HTTPS, activate cards and update inventory with balances. This API requires integration between merchants and the system. By way of example, Myer™ relies on a Vii third party processor while David Jones™ uses a Magento third party processor.

### Registration/Login

New customer users can register with the system using their social media accounts such as Facebook™, LinkedIn™, Google™ accounts or via Email and Password. For registration using a social media account, the system uses the official SDKs (Software Developer Kits) of the associated social platforms which use a variety of authentication mechanisms (typically OAuth) where a token is swapped for credentials.

Embodiments of the system use Django OAuth Toolkit and Python Social Auth that provides the mechanism for a user to swap a token from a successful login via social platform such as Facebook for a system platform OAuth2 token. However, it will be appreciated that the system may be configured with other authorization standards, web frameworks and programming languages. As a user uses the mobile app, each request has a HTTP header attached that includes the token. This token is unique to the user and acts in place of a username and password.

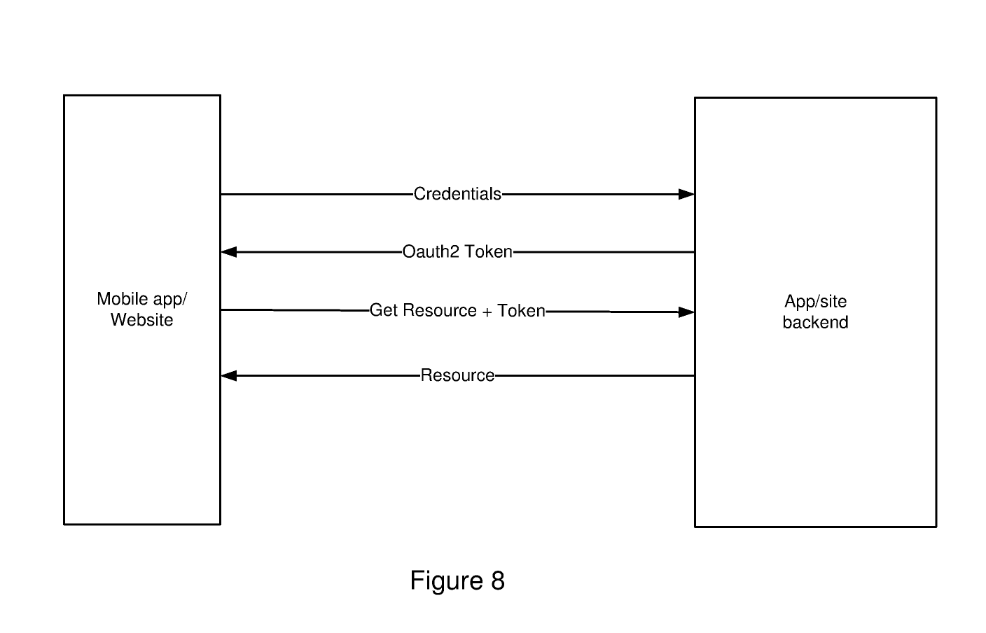

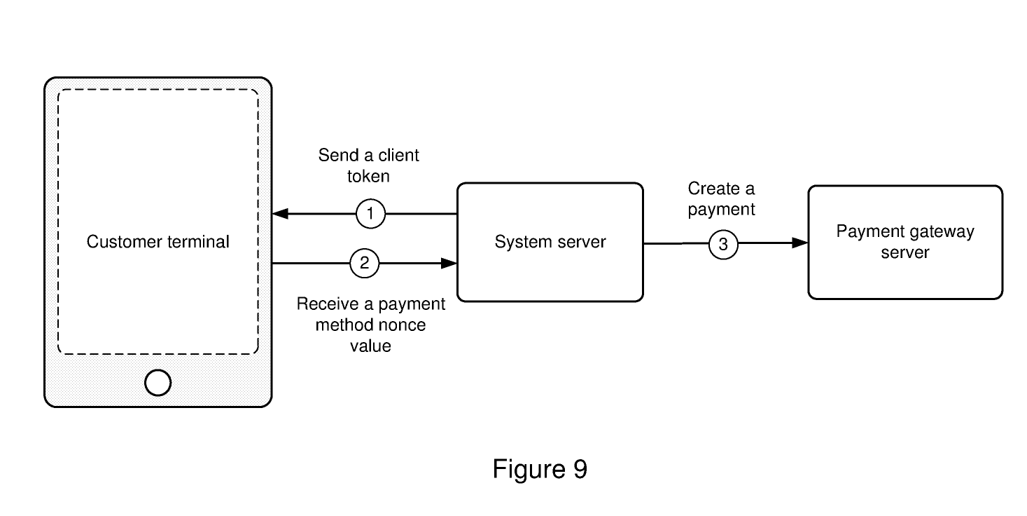

As the token is used for each request, it needs to be securely stored on the user's customer terminal (such as a mobile device). To do this, the token is stored in the device's secure keychain. This token authentication process is illustrated schematically in FIG. 8.

All financial transactions through the system are performed by an external payment gateway provider such as Braintree™. System administrators are not able to see or access any credit card details for the customer users. This is done entirely through the payment gateway provider's software development kit (SDK), which communicates securely with the gateway provider.

Referring now to FIG. 9, from a payment processing point of view, to purchase an electronic gift card, the following procedure is performed:
1. The mobile app 46 (or software application in the case of a personal computer) installed on the customer terminal requests a customer token from app/site backend 42 to initialise the payment gateway SDK.
2. Using the SDK, app/site backend 42 generates and sends a customer token back to the mobile app.
3. Once the SDK is initialised it communicates with the payment gateway provider (sending the user's credit card/payment details), which returns a payment method nonce to the customer terminal.
4. Mobile app 46 then sends the payment nonce to app/site backend 42.
5. App/site backend 42 receives the payment method nonce from mobile app 46 and then uses the payment gateway provider to complete the purchase.
6. If the payment is successful, the inventory item (electronic gift card) is activated securely via the API.

Order details are stored on the merchant backend with customers only identified anonymously by a universally unique identifier (UUID). No personally identifiable customer details are accessible from the merchant platform.

For security, as a default, tokens expire after a predetermined time period such as one month and the user is then required to log in again on the device to get a new token. Tokens can be revoked by system administrators at any time if required.

### User Data

The essential user information that system 1 maintains includes:
1. The Digital Wallet—A list of the cards that a customer user has available to them for use.
2. The Card History—A list of expired, received and sent electronic gift cards.
3. Non-financial personal information such as email, name, etc.
4. User settings/preferences.

System 1 does not store or manage any credit card or personal financial/payment information. Personal and financial information is managed externally such as through payment gateway services and the like.

### Digital Wallet Feature

The digital wallet feature stores the collection of gift cards or merchant credits a user has purchased for themselves or has received as a gift from others. Each card in the digital wallet has a number and (depending on the merchant) a PIN.

When a card is purchased through the system, the card must be activated with the merchant to be able to be redeemed. Once the card has been activated, it can be used by the user as credit in the merchant's store. The merchant credit can be used through a merchant's online store or in brick-and-mortar stores through POS terminals.

### Conclusions

It will be appreciated that the above described invention provides significant systems and methods of creating a personalised data package including a value of merchant-specific credits.

Embodiments of the present invention provide an online electronic gift card platform connecting consumers and retailers to buy, send, store, redeem and re-gift electronic gift cards in a convenient single online platform. This new platform allows an unprecedented improvement of service to the industry, for user and retailer alike. Specifically:
For the user: Users will be able to purchase and receive gift cards with the personal touch of digital interaction. This includes the addition of personal text, audio, image, or video messages to gift cards, scheduled delivery of the card and even the ability to share the gift socially with friends on Facebook. In addition, users will also be notified of expiry dates, gift card terms and conditions while being connected to their friends via Twitter, Facebook, Google+ and LinkedIn. This social functionality will allow users to be notified of upcoming birthdays and special events, and conveniently send e-gift cards instantly with a personal greeting card.
For retailers: The system will creates a meaningful new distribution channel for retailers, increasing sales and giving brands visibility into the mobile digital world. With gift cards gaining popularity with major retail brands, having an electronic gift card option allows retailers to compete in crowded verticals. The electronic nature of electronic gift cards saves time and money over shipping and handling plastic cards. In addition, if the electronic gift card has the capability to be reloaded or track loyalty points, it can serve as a tool to increase customer loyalty—for instance by incentivizing the initial purchase with a promotional offer for the buyer, such as a mini gift card or a discount on another purchase.

From a technical perspective, the present invention allows merchants to issue gift cards without having to create a brand new in-house system or having to contract several providers to enable such transactions. The present invention also addresses the complexity of different merchants having multiple SKU types (normal, premium, etc.), each which could have multiple themes (graphic designs), and in turn could have many fixed denominations. The invention allows for management of inventory and orders automatically for merchants. It also provides the inventory API for the backend to fetch and update the customer digital wallet or card details. The present invention also provides for integration with different merchants who utilise varied e-commerce systems and processes, and merchants having unique inventory handling requirements. By way of example, Myer™ relies on a Vii third party processor while David Jones™ uses a Magento third party processor. The present invention as adapted to integrate these various ecommerce systems to provide a seamless process for both customers and merchants to conduct transactions of merchant specific credit.

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to include, but not be limited to, solid-state memories, a computer product embodied in optical and magnetic media; a medium bearing a propagated signal detectable by at least one processor or one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (e.g., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Thus, while there has been described what are believed to be the best modes of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A system for creating one or more personalised data packages, each having an associated value of merchant-specific credits, the system including a server configured to:
receive a request from a customer terminal for creation of one or more personalised data packages, the request including one or more specified recipients, one or more specified merchants selected from a plurality of merchants and a specified value of merchant-specific credits specific to the specified merchants for each of the personalised data packages;
obtain or verify payment of an amount representative of the total value of merchant-specific credits for all of the personalised data packages;
in response to receiving the secure payment, access a database to generate a visual template for each of the personalised data packages, the visual template being indicative of a visual representation of the personalised data packages when rendered on an electronic display; and
provide an interface accessible by the customer terminal to allow personalisation of the visual template to update the personalised data packages to include one or more of:
uploading and embedding of image and/or video content to the data packages;
embedding of personalised text content to the data packages;
embedding of audio content to the data packages; and
embedding of interactive content to the data packages;
wherein the personalised data packages are able to be accessed by the specified recipients via recipient terminals.

2. A system according to claim 1 wherein the visual template includes a logo of the specified merchant.

3. A system according to claim 1 wherein the server is further configured to electronically transmit the personalised data packages to a specified recipient.

4.-7. (canceled)

8. A system according to claim 1 wherein the personalised data packages include data indicative of an expiry date for using the specified value of merchant-specific credits.

9. A system according to claim 8 wherein the server is further configured to issue a notification to the specified recipient about the expiry date at a predetermined time before the expiry date.

10.-11. (canceled)

12. A system according to claim 1 wherein the interactive content includes visual content renderable on a display of an electronic device which requires input by the specified recipients at an interface to selectively reveal the specified value.

13. (canceled)

14. A system according to claim 1 wherein the personalised data packages include a unique reference identifier.

15. A system according to claim 1 wherein the personalised data package includes a timestamp and datestamp corresponding to the time and date that it was activated and/or created.

16. A system according to claim 1 wherein the personalised data packages are in a format such that it can be stored in a digital wallet and the credit redeemed at a point of sale using the digital wallet.

17. A system according to claim 1 wherein the personalised data packages are able to be sold or traded through the interface.

18. A system according to claim 17 wherein the server is configured to allow the recipients to access the interface to change the specified merchant to another merchant registered with the system.

19. A system according to claim 17 wherein the server is configured to allow the recipients to access the interface to modify the personalised data packages.

20. (canceled)

21. A system according to claim 1 wherein the secure payment is performed using a token-based authentication protocol.

22.-23 (canceled)

24. A system according to claim 1 wherein the merchant is an entity associated with the system.

25. A system according to claim 24 wherein the merchant associated with the system holds credits in escrow which can be converted to credits specific to another merchant.

26. A system according to claim 1 wherein the payment is received by the server accessing an online payment gateway.

27. A method for creating one or more personalised data packages, each having an associated value of merchant-specific credits, the method including:
a) receiving a request from a customer terminal for creation of one or more personalised data packages, the request including one or more specified recipients, one or more specified merchants and a specified value of merchant-specific credits specific to the specified merchant for each of the personalised data packages;
b) obtain or verify payment of an amount representative of the total value of merchant-specific credits for all of the personalised data packages;
c) in response to receiving the secure payment, accessing a database to generate a visual template for each of the personalised data packages, the visual template being indicative of a visual representation of the personalised data package when rendered on an electronic display;
d) providing an interface accessible by the customer terminal through a server to allow personalisation of the visual template to update the personalised data packages to include one or more of:
uploading and embedding of image and/or video content to the data packages;
embedding of personalised text content to the data packages;
embedding of audio content to the data packages; and
embedding of interactive content to the data packages; and
e) providing access to the personalised data packages by the specified recipients via recipient terminals.

28. A system for converting a currency payment into a value of merchant-specific credit to be used at one of a plurality of subscribed merchants, the system including a server configured to:
provide an interface accessible by a customer terminal for receiving a request from an input user device for a specified value of merchant-specific credit that is specific to one of the subscribed merchants, the request including the specified value and a specified merchant;
in response to the request, determining a current value of credits held on account for the specified merchant;
if the current value of credits is less than the specified value, communicate electronically with a server of the specified merchant to place a purchase order with the specified merchant for at least the difference between the current value of credits and the specified value, the purchase order being carried out using the specified e-commerce protocols of the specified merchant;
provide access of the customer terminal to a payment gateway for securely transferring the currency payment for the specified value to a third party; and
in response to the secure transfer of the currency payment, allocate the specified amount of merchant-specific credit to an account of a user;
wherein the merchant-specific credit is able to be redeemed at a point-of-sale interface of the specified merchant.

29. A system according to claim 28 wherein at least two of the subscribed merchants include different specified e-commerce protocols.

30. (canceled)

31. A system according to claim 28 wherein the point-of-sale interface of the specified merchant includes an in-store physical point-of-sale terminal.
